(19) United States
(12) Patent Application Publication
(10) Pub. No.: US 2002/0033271 A1
(43) Pub. Date: Mar. 21, 2002

(54) Multiple cable

(76) Inventors: Claus Fritschle, Stuttgart (DE); Klaus Heesen, Stuttgart (DE)

Correspondence Address: HARNESS, DICKEY & PIERCE, PLC, P.O. BOX 828, BLOOMFIELD HILLS, MI, 48303, US

(21) Appl. No.: 09/954,804

(22) Filed: Sep. 18, 2001

Related U.S. Application Data
(63) Continuation of application No. PCT/EP00/02390, filed on Mar. 17, 2000.

(30) Foreign Application Priority Data
Mar. 18, 1999 (DE) 299 04 944.2

(51) Int. Cl. H01B 7/08

(52) U.S. Cl. 174/117 F

(57) ABSTRACT

The invention relates to a multiple cable with a plurality of leads that have a dimensionally stable flat configuration, one beside the other, at least in their end portions and that are interlinked in the fashion of a flat strip cable. The leads are at least partially detached from one another in at least one zone of separation between two flat zones.

### RELATED APPLICATIONS

This application is a continuation application of PCT/EP00/02390, filed on Mar. 17, 2000 and claiming priority of German application DE 29 904 944 filed on Mar. 18, 1999.

### BACKGROUND OF THE INVENTION

The present invention relates to a multiple cable having a plurality of leads.

### DESCRIPTION OF THE RELATED ART

Multiple cables of this type are known, particularly in the field of computer technology. For example, such multiple cables are used as flat-band cables for internal bus connections between CD-ROM- or hard disk drives and a respective IDE- or SCSI-controller. Midget plug connections of different kinds, mostly in the form of wide edgeboard connections, can be used as plug connections. Further types of cables are disclosed in U.S. Pat. Nos. 4,992,625, 5,834,698, 5,767,442 or U.S. Pat. No. 4,880,943.

One of the difficulties related with such flat-band cables is that they can easily be vertically bent relative to the plane of extension, however, they can hardly be bent in other directions or only by using complex cable ducts.

### BRIEF SUMMARY OF THE INVENTION

It is the object of the present invention to provide a multiple cable of the aforementioned kind which overcomes the disadvantages of the prior art, which can be used for multiple purposes and which can be used and produced at low costs and efforts.

This object is solved by the features of claim 1. The leads may be interlinked at least in their end portions in a dimensionally stable, particularly parallel, flat configuration in the fashion of a flat-band cable. Thereby, the end portions are formed as flat portions or flat zones. In at least one separation zone between two end portions and flat portions, respectively, the leads may at least partly be detached or separated from each other, this separation extending preferably across the whole separation zone. By the at least partial separation of the interconnection or interlink of the parallel extending leads, the multiple cable may be bent in the separation zone more easily, particularly in any direction, like any bunch of not interlinked leads.

In view of the structure, the leads may have at least one, preferably a plurality of metal strands comprising a cable sheath of a plastic material. Preferably, all metal strands are covered by the plastic insulation in the flat zones and are integrally interconnected. The plastic insulation may be preferably comprised of one layer, for example may be fabricated in a single step by a common fabrication process by coating the metal strands and concurrently connecting the leads. A multiple cable may comprise a plurality of leads, particularly an even number, preferably at least 25, with an upper limit of 68 leads being considered as sufficient for most application fields. Most preferably, at least 34 leads are provided.

Preferably, the leads extend along the separation zone in groups of maximum 3 interconnected leads, particularly in pairs of 2 interconnected leads each. This is advantageous if a continuous extending flat-band cable is detached in the separation zone at a later time, so as to limit the number of separations. Preferably, at least one part of the leads, particularly all leads, are extending in the at least one separation zone singularly and detached from the other leads. Thereby, a maximum flexibility of the multiple cable is achieved in the separation zone due to the maximum movability of the single leads relative to each other.

The handling of the multiple cable may be increased if individual leads extend along the separation zone in a combined or bunched fashion, particularly all leads extend detached in a bunch, for example in the fashion of a round cable with multiple leads. Preferably, the multiple cable comprises at least partially a supporting and/or connecting sheath combining the leads to a bunch. A sheath may be advantageously formed as a hose, for example as a spiral hose cut open or textile hose or elastic hose, the hose being substantially tight. Preferably, the textile hose is made of a nylon aramite mesh. A sheath may provide an additional protection against mechanical effects on the leads and/or an additional electrical insulation. Preferably, the sheaths are made of a flexible plastic, for example PVC.

A further embodiment of a sheath may be provided with a shielding, particularly a shielding of the leads against electromagnetic stray fields. Such a shielding advantageously comprises metal, for example in form of a cover made by connected metal threads or a rolled metal foil. Preferably, a sheath with a shielding comprises at least one electrical insulation located at the surface, particularly at the outside, in order to avoid short circuits and undesired contacts, respectively, through the metal shielding.

Preferably, at least one further flat zone is provided between the end portions or the flat portions forming the end portions. Preferably, a plurality of flat zones is provided. Preferably, between each two flat zones a separation zone is provided. In this separation zone the leads are detached from each other in the described manner and might be covered. At least at the end portions, particularly at each flat zone, connection means may be provided for connecting at least two electrical connections via the multiple cable. Preferably, the connection means are plug connections, particularly plug couplings. According to one preferred embodiment, a multiple cable is formed in a looping-through fashion, that means that a plurality of connection means are provided along its extension which do not interrupt the cable or which might be electrically contacted.

Generally, the above-described multiple cable may be employed in many applications. Preferably, such applications lie in the field of connecting technology for computers and computer components, respectively. The leads may be thin, preferably having a cross section area of about 0.01 mm² to 1 mm², particularly about 0.07 mm². The outer diameter of individual leads, the outer diameter preferably corresponding to the height of the multiple cable in the flat zone, may be in the range of 0.3 mm to 2 mm, particularly about 0.8 mm. The flat zones and the end portions, respectively, of the multiple cable may extend about a length of at least 5 mm, with a maximum length of preferably 20 mm. Particularly, the length may be 10 mm. This will be considered as sufficient to keep the flat zone flat as well as the leads in this zone parallel in response to mechanical load and effects on the multiple cable or the individual leads.

For the above-mentioned type of multiple cables or leads, plug connections as connection means are preferably used, the plug connections concurrently contacting the leads while assembled. Plugs of this kind are known under the names “CENTRONICS” or “MINICENTRONICS”.

The two halves of the plug can be guided by a flat zone with the parallel guided leads and may be interlinked. Contact studs connected with plug contacts extend through the insulation of the lead and contact the metal strands. This connection technique avoids complicated skinning of individual leads.

According to a preferred embodiment of the invention, the multiple cable comprises plug connections in flat zones and is a connecting cable for data transmission, particularly in computer systems. Preferably, it is a bus cable connecting at least one storage medium drive with at least one further storage medium drive and/or a central processing unit.

The multiple cable is fabricated either by fabricating individual leads and connecting these leads with each other subsequently as to form the above-described flat zones. Possibilities for interconnecting may be gluing the individual leads together with additional adhesives or by melting the individual lead insulation and joining together subsequently. Thereby, the leads are interconnected only in the predetermined flat zones. Alternatively, the connection possibilities can comprise mechanical connection means, for example clamps, clasps, or the like. A sheath or cover will preferably be put over the separation zones after having connected the individual leads.

Another fabrication process starts from the conventional known flat-band cable having a plurality of leads. The flat-band cable is detached in the predetermined separation zones for example by cutting or detaching or loosening the small connection links between the leads. The cutting process can be carried out with knife blades, being preferably disposed parallel as to form multiple knives and being pulled over the separation zone. Preferably, roller blades may be employed, also forming a plurality of roller blades arranged side by side. A further possibility may be to punch the flat zone with a plurality of blades. Guides may be provided as to cut exactly between two leads to avoid in any case a cut through the insulation to the metal strands. As described above, the sheath or cover is then put over the separation zone. Connection means, particularly plug connections, may be provided either directly after the fabrication of the multiple cable or at a later time in the case of extra packaging.

These and other features arise from the description and the drawings as well as from the claims. Individual features may be implemented alone or in combination with other features forming an embodiment of the present invention, and on other fields. The separation of the application in different sections as well as sub-headings will not limit the description in view of its generality.

### BRIEF DESCRIPTION OF THE DRAWINGS

An embodiment of the invention is illustrated in the drawings and will be described in the following. In the drawings:

FIG. 1 shows an enlarged view of a multiple cable having a bunched separation zone and a succeeding flat zone passing over to a plug coupling, and

FIG. 2 shows a multiple cable with a plurality of separation zones and a plurality of flat zones where plug couplings are located.

### DETAILED DESCRIPTION OF THE EMBODIMENT

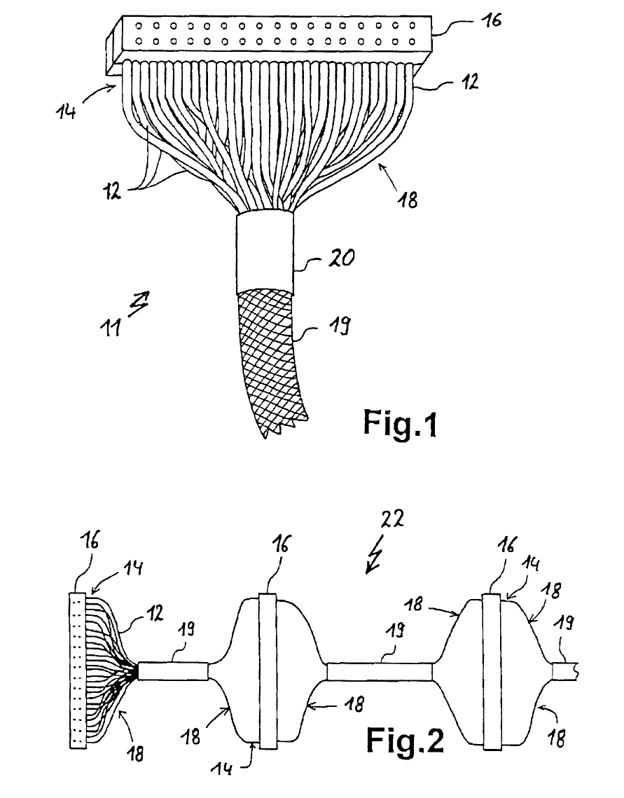

FIG. 1 illustrates a multiple cable 11 which comprises a plurality of leads 12. The leads 12 are interconnected or interlinked in a flat, single layer, parallel and side by side manner along a flat zone 14, preferably, via the casted plastic insulation of the leads. The leads are arranged in this flat zone 14 in the fashion of a flat-band cable. A plug coupling 16 is provided receiving the ends of the leads 12 and the ends of the flat zones 14, respectively, and is connected with the leads.

Following the flat zone 14, the leads 12 are detached or separated from each other. For example, in FIG. 1 all leads are detached from each other. The wide ribbon of leads 12 is put together in the separation zone 18 as to form a bunch having a circular cross section. A sheath 19 is put over the separation zone 18. The sheath 19 is made of a textile mesh-structured hose, preferrably a nylon aramite mesh. The entrance of the leads 12 into the sheath 19 is reinforced by a collar 20 as to avoid expanding or bursting of the sheath 19. The collar 20 may be made for example of a plastic hose or a heat-shrinkable sleeve.

FIG. 2 shows a connection cable 22 formed from a multiple cable 11. The connection cable 22 comprises a plurality of flat zones 14 as well as separation zones 18 arranged therebetween. The flat zones 14 and the separation zones 18 are shown in FIG. 2 only schematically, however, details are given in FIG. 1. A larger part of the separation zones 18 are each provided with a sheath 19 similar as in FIG. 1.

The flat zones 14 are provided with plug couplings 16 at the end portions as well as along the extension of the connection cable 22. A connection cable 22 may be employed as bus cable in a personal computer or a larger computing device, for example between storage medium drives and the bus controller.

In the separation zones 18, particularly with the sheath 19 put over, the multiple cable 11 may be flexibly bent or guided in a wide extent, since individual leads can be shifted or moved relative to each other. The sheath 19 may not be placed upon the leads 12 too tightly in order to prevent any negative effect on the movability of the leads 12.

Further possibilities for plug connections are the so-called SUBD, HPSUBD or HD plug connections. Here it has to be noted that the leads are normally skinned and the exposed metal strands have to be soldered with metal contacts.

Further, it is possible to divide the multiple cable in a plurality of separated separation zones. These could for example be formed in the fashion of smaller flat-band cables and could particularly be provided with connection means each. A subdivision in bunched separation zones formed of individual leads and portions, in which the leads form at least one flat zone, is possible. This arrangement may provide different portions disposed parallel or in series.

1. Multiple cable with a plurality of leads having a dimensionally stable flat configuration, one beside the other, at least in their end portions and are interlinked in the fashion of a flat-band cable, the leads being at least partially detached from one another in at least one zone of separation (separation zone) between two flat zones, all leads extending separately in a detached bunch, and the bunch being covered by a hose-shaped sheath, wherein the sheath is reinforced at both ends by a collar as to avoid expanding or bursting of the sheath.

2. Multiple cable according to claim 1, wherein each lead comprises at least one, preferably a plurality of metal strands being totally covered by a plastic insulation, preferably all leads and metal strands, respectively, are integrally interlinked via the plastic insulation in the flat zones and the plastic insulation being comprised of particularly one layer.

3. Multiple cable according to claim 1, wherein the number of leads is preferably at least 25 and maximum 69, particularly at least 34.

4. Multiple cable according to claim 1, wherein the leads are arranged in at least one separation zone in groups of maximum three interlinked leads, particularly in pairs of two connected leads.

5. Multiple cable according to claim 1, wherein the sheath is arranged in the form of a hose.

6. Multiple cable according to claim 1, wherein the sheath is provided as a partially, particularly totally, electrical isolating sheath.

7. Multiple cable according to claim 1, wherein the sheath is provided as a mesh structure, preferably made from nylon aramite fibers.

8. Multiple cable according to claim 1, wherein the sheath comprises a shielding, preferably in form of a cover made of connected metal threads, the shielding preferably comprising an electrical insulation on a surface, preferably on its outer surface.

9. Multiple cable according to claim 1, wherein further flat zones are formed between the end portions, one separation zone being formed particularly between at least one end portion and the adjacent flat zone, preferably a separation zone being provided between each two flat zones.

10. Multiple cable according to claim 1, wherein connection means for connecting at least two electrical connections with each other via the multiple cable are provided at least at the end portions, particularly at all flat zones, the connection means are preferably provided as plug connections, particularly plug couplings.

11. Multiple cable according to claim 1, wherein the leads are thin, having a cross-sectional area in the range of 0.01 mm² and 1 mm², particularly about 0.07 mm².

12. Multiple cable according to claim 1, wherein the outer diameter of each lead is in the range of 0.3 mm to 2 mm, particularly about 0.8 mm.

13. Multiple cable according to claim 1, wherein the flat zones, particularly the end portions, have a length of at least 5 mm, particularly about 10 mm, preferably maximum 20 mm.

14. Multiple cable according to claim 1, wherein plug connections are provided and the multiple cable is formed as a connection cable for data transmission, particularly in computer systems, the multiple cable being preferably provided as a bus cable connecting at least one data storage drive with at least a further data storage drive and/or a central processing unit.
